(19) United States
(12) Patent Application Publication
(10) Pub. No.: US 2024/0348556 A1
(43) Pub. Date: Oct. 17, 2024

(54) COMMUNICATION DEVICE, COMMUNICATION SYSTEM, AND COMMUNICATION METHOD

(71) Applicant: NIPPON TELEGRAPH AND TELEPHONE CORPORATION, Tokyo (JP)

(72) Inventors: Yuhei KAWAKAMI, Tokyo (JP); Shinichi YOSHIHARA, Tokyo (JP); Hideo KAWATA, Tokyo (JP); Takahiro KUBO, Tokyo (JP)

(73) Assignee: NIPPON TELEGRAPH AND TELEPHONE CORPORATION, Tokyo (JP)

(21) Appl. No.: 18/294,497

(22) PCT Filed: Aug. 4, 2021
(86) PCT No.: PCT/JP2021/029015

§ 371 Date: Feb. 1, 2024

(51) Int. Cl. H04L 47/56; H04L 47/10; H04L 47/2441; H04L 47/283; H04L 47/6275

(52) U.S. Cl. CPC H04L 47/56; H04L 47/18; H04L 47/2441; H04L 47/6275; H04L 47/283

(57) ABSTRACT

A communication device (1) according to the present disclosure includes: a frame receiving part (11) which receives a frame; a determining part (12) which determines a user identifier and a priority traffic class; a plurality of queues (13) which each hold frames for each user identifier and priority traffic class; a list storage part (15) which stores a gate control list indicating times of a plurality of time slots and open/closed states which are either open states or closed states of a plurality of gates (14), a gate opening/closing part (17) which controls open/closed states of the plurality of gates; and a frame transmitting part (18) which transmits frames held in a queue (13-k) corresponding to a gate (14-k) controlled to be in an open state, in which at least one time slot in the gate control list is a delay guarantee period.

### TECHNICAL FIELD

The present disclosure relates to a communication device, a communication system, and a communication method.

### BACKGROUND ART

In the related art, a standard called time sensitive networking (TSN) has been established as a technique for minimizing delays in a device caused by congestion at relay nodes and preventing the occurrence of delay fluctuations. In the time aware shaper (TAS) technique in the TSN standard, the time slot (TS) corresponding to the priority traffic class (for example, class of service (Cos) value) is coordinated between nodes and a gate control list (gate control list: GCL) to prevent the occurrence of congestion.

For example, in the example shown in FIG. 11, a period during which the TS indicated in the GCL is “0” (TS “0”) is set as a guard band (GB) period during which the transmission of a frame provided between the best effort (BE) transmission period and the delay guarantee period is not started. The BE transmission period is a period during which frames are transmitted with best effort. The delay guarantee period is a period during which the frame received from the transmitting device through delay guaranteed communication is transmitted. The GB period is a period during which the communication device does not start transmitting frames. Thus, for example, when there is a delay in frame transmission in the TS immediately before the GB period, the delayed frame transmission can be terminated in TS “0” which is the GB period. As a result, it is possible to prevent the delay caused by the frame whose transmission is started in the TS before TS “1” in TS “1” following TS “0”. Note that, in FIG. 11, “o” indicates that the gate corresponding to the queue holding the frame is controlled to be in an open state. Also, “c” indicates that the gate corresponding to the queue holding the frame is controlled to be in a closed state.

### CITATION LIST

### Patent Literature

[PTL 1] Japanese Patent Application Publication No. 2020-136777

### SUMMARY OF INVENTION

### Technical Problem

However, in the technique in the related art, the priority traffic class of frames received by a communication device from a plurality of transmitting devices (for example, talkers) as delay-guaranteed communication (scheduled traffic (ST) communication) may be the same. The delay-guaranteed communication is communication in which a maximum value of an end-to-end delay of communication is defined and needs to be satisfied. When the service provider provides the delay guarantee, the delay guarantee may be stipulated by contract between the user and the service provider using the communication device. In delay-guaranteed communication, a communication device realizes delay guarantee by transmitting within a predetermined TS, a frame of a predetermined length having a predetermined priority traffic class received from a transmitting device at a predetermined timing. A communication device is required for transmitting a frame received from a transmitting device through delay guaranteed communication without a delay.

The GCL of the example shown in FIG. 11 indicates that the TAS queue corresponding to the priority traffic class “7” in TS “1” is controlled to be in an open state (o). The open state of TS “1” and the priority traffic class “7” in the GCL are set so that the communication device transmits a frame received as delay-guaranteed communication from one transmitting device out of a plurality of transmitting devices within a guaranteed period. It also shows that the TAS queue corresponding to the priority traffic class “7” is controlled to be in the open state (o) in TS “3”. The open state of TS “3” and the priority traffic class “7” in the GCL is set so that the communication device transmits frames received as delay-guaranteed communication from other transmitting devices among a plurality of transmitting devices within a guaranteed period.

In this example, if a frame of the priority traffic class “7” with one user identifier is delayed and the communication device receives the frame at TS “3” as shown in FIG. 12, the communication device may transmit the frame with TS “3” in some cases. In this case, the communication device does not transmit the frame of the priority traffic class “7” with another user identifier different from the one user identifier described above, but holds it in the queue until TS “3” of the next period. This delays the transmission of frames of the priority traffic class “7” with other user identifiers.

In this way, one of a plurality of transmitting devices which transmit frames to a communication device may delay transmission of frames through delay guaranteed communication due to malfunction or malicious communication in some cases. In this case, a frame received as delay-guaranteed communication from another transmitting device may be delayed in some cases.

The present disclosure was made in view of such circumstances, and an object of the present disclosure is to provide a communication device, a communication system, and a communication method which can more reliably prevent a delay of frames transmitted through delay guaranteed communication.

### Solution to Problem

In order to solve the above problems, a communication device according to the present disclosure includes: a frame receiving part which receives frames from a plurality of transmitting devices; a determining part which determines a user identifier for identifying a user of the transmitting device which has transmitted the frames and a priority traffic class which indicates a priority of the frames; a plurality of queues which hold the frame for each of the user identifier and the priority traffic class; a list storage part which stores a gate control list indicating times in a plurality of time slots and open/closed states which are either an open state or a closed state of a plurality of gates corresponding to a plurality of queues in each of the plurality of time slots; a gate opening/closing part which controls the open/closed states of the plurality of gates on the basis of a current time and the gate control list; and a frame transmitting part which transmits the frames held in the queue corresponding to the gate controlled to be in the open state in an order in which the frames are received, wherein at least one time slot among the plurality of time slots in the gate control list is a delay guarantee period during which the time and the opening/closing state are defined so that a frame received at a predetermined timing from a predetermined transmitting device is transmitted in the time slot.

In order to solve the above problems, a communication system according to the present disclosure includes a plurality of transmitting devices and a communication device which receives frames from each of the plurality of transmitting devices, wherein the communication device includes: a frame receiving part which receives frames from the plurality of transmitting devices; a determining part which determines a user identifier for identifying a user of the transmitting device which has transmitted one of the frames and a priority traffic class which indicates a priority of the frame; a plurality of queues which hold the frames for each of the user identifiers and the priority traffic classes; a list storage part which stores a gate control list indicating times for each of a plurality of time slots and open/closed states of a plurality of gates corresponding to the plurality of queues in each of the plurality of time slots; a gate opening/closing part which controls the open/closed states of the plurality of gates on the basis of a current time and the gate control list; and a frame transmitting part which transmits the frames held in the queue corresponding to the gate controlled to be in the open state in an order in which the frames are received, and wherein at least one time slot among the plurality of time slots in the gate control list is a delay guarantee period during which the time and the opening/closing state are defined so that a frame received at a predetermined timing from a predetermined transmitting device is transmitted in the time slot.

In order to solve the above problems, a communication method according to the present disclosure is performed by a communication device including a storage part which stores a gate control list indicating times of a plurality of time slots and open/closed states of a plurality of gates corresponding to the plurality of queues in each of the plurality of time slots, includes: a step of receiving frames from a plurality of transmitting devices; a step of determining a user identifier for identifying a user of the transmitting device which has transmitted the frame and a priority traffic class indicating a priority of the frame; a step of holding the frame in each of the queues for each user identifier and priority traffic class; a step of controlling the open/closed states of the plurality of gates on the basis of a current time and the gate control list; and a step of transmitting the frames held in the queue corresponding to the gate controlled to be in the open state in the order in which the frames are received, wherein at least one time slot among the plurality of time slots in the gate control list is a delay guarantee period in which the time and the open/closed state are defined so that a frame received at a predetermined timing from a predetermined transmitting device is transmitted in the time slot.

### Advantageous Effects of Invention

According to a communication device, a communication system, and a communication method according to the present disclosure, it is possible to more reliably prevent a delay of frames transmitted through delay guaranteed communication.

### BRIEF DESCRIPTION OF DRAWINGS

FIG. 1 is a schematic diagram of a communication device according to a first embodiment.

FIG. 2 is a diagram showing an example of a GCL stored in a list storage part shown in FIG. 1.

FIG. 3 is a timing chart of frame transmission using a communication device shown in FIG. 1.

FIG. 4A is a flowchart for describing an example of an operation for holding a frame using the communication device according to the first embodiment.

FIG. 4B is a flowchart for describing an example of an operation for transmitting a held frame using the communication device according to the first embodiment.

FIG. 5 is a diagram showing an example of a GCL stored in a list storage part according to a second embodiment.

FIG. 6 is a timing chart of frame transmission based on the GCL shown in FIG. 5 using the communication device.

FIG. 7 is a schematic diagram of a communication device according to a third embodiment.

FIG. 8 is a timing chart of frame transmission using the communication device shown in FIG. 7.

FIG. 9A is a flowchart for describing an example of an operation for holding a frame using the communication device according to the third embodiment.

FIG. 9B is a flowchart for describing an example of an operation for transmitting a held frame using the communication device according to the third embodiment.

FIG. 10 is a hardware block diagram of a communication device.

FIG. 11 is a diagram showing an example of a GCL stored in a communication device in the related art.

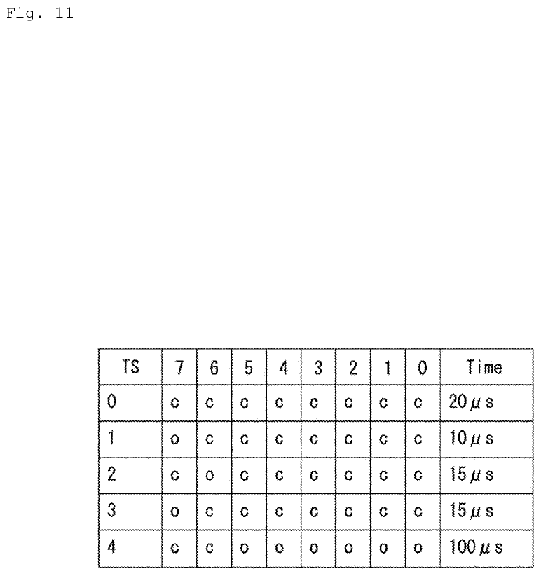

FIG. 12 is a timing chart of frame transmission based on the GCL shown in FIG. 11 using the communication device in the related art.

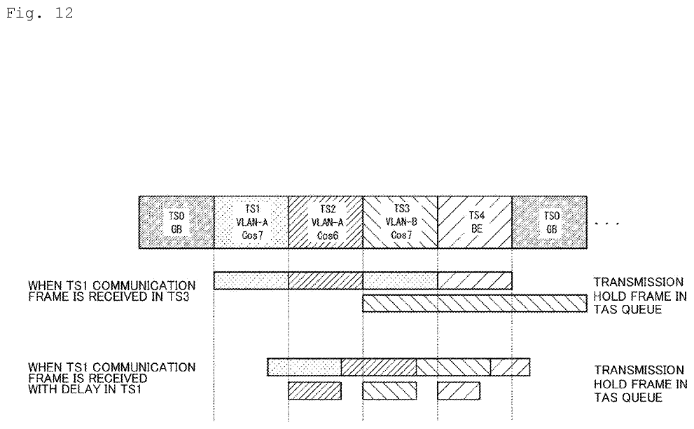

### DESCRIPTION OF EMBODIMENTS

### First Embodiment

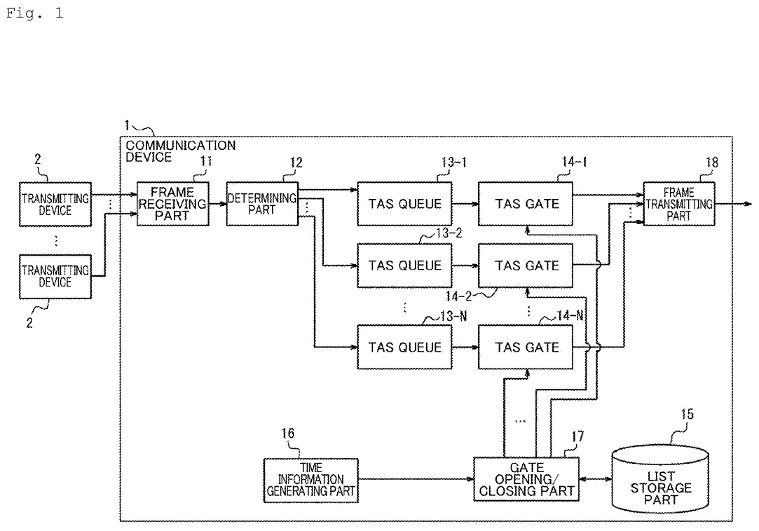

The overall configuration of a first embodiment will be described with reference to FIG. 1. FIG. 1 is a schematic diagram of a communication device 1 according to the first embodiment. The communication device 1 receives frames from a plurality of other transmitting devices 2 over a communication network. Also, a communication system 100 may be configured to include the plurality of transmitting devices 2 and the communication device 1 which receives frames from each of the plurality of transmitting devices 2.

### <Configuration of Communication Device>

As shown in FIG. 1, the communication device 1 according to the first embodiment performs communication using a TAS technique in the TSN standard. The communication device 1 includes a frame receiving part 11, a determining part 12, a plurality of TAS queues (queues) 13 (13-1 to 13-N), a plurality of TAS gates (gates) 14 (14-1 to 14-N), a list storage part 15, a time information generating part 16, a gate opening/closing part 17, and a frame transmitting part 18. Here, N is the number of TAS queues 13 and the number of TAS gates 14.

The frame receiving part 11 and the frame transmitting part 18 are configured using a communication interface. For example, standards such as the Ethernet (registered trademark), the fiber distributed data interface (FDDI), and wireless fidelity (Wi-Fi) (registered trademark) may be used for the communication interface. The determining part 12, the TAS gate 14, and the gate opening/closing part 17 are configured by a control part (controller). The control part may be configured of dedicated hardware such as an application specific integrated circuit (ASIC) or a field-programmable gate array (FPGA), configured of a processor, or configured to include these. The TAS queue 13 is made up of a buffer memory and the list storage part 15 is made up of a memory. The buffer memory and the memory may be a hard disk drive (HDD), a solid state drive (SSD), an electrically erasable programmable read-only memory (EEPROM), a read only memory (ROM), a random access memory (RAM), and the like.

The frame receiving part 11 receives frames from a plurality of transmitting devices 2.

A frame includes a user identifier for identifying a user of the transmitting device 2 which has transmitted the frames. The user identifier can be, for example, a VLAN identifier for identifying a virtual local area network (VLAN) to which the transmitting device 2 used by the user belongs.

In addition, the frame includes a priority traffic class indicating a degree (priority) of preferential transmission using the communication device 1. A priority traffic class can be represented by, for example, a class of service (Cos) value.

The determining part 12 determines a user identifier for identifying the user of the transmitting device 2 which has transmitted the frame and a priority traffic class indicating the priority of the frame. The determining part 12 inputs the frame to one of the TAS queues 13 on the basis of the user identifier and the priority traffic class. Specifically, the determining part 12 inputs frames having the same user identifier and priority traffic class to the same TAS queue 13.

The TAS queues 13 hold frames for each user identifier and priority traffic class. That is to say, the number N of TAS queues 13 is the number of user identifiers multiplied by the number of priority traffic classes. Also, the TAS queue 13 also holds frames so that the order in which they are received is identifiable.

A TAS gate 14-k (k is an integer from 1 to N) is provided corresponding to the TAS queue 13-k. The TAS gate 14 is controlled to be in either an open state or a closed state (open/closed state) by a gate opening/closing part 17 which will be described in detail later. When controlled such that it has been brought into an open state, the TAS gate 14 extracts the earliest received frame among the frames held in the TAS queue 13. Also, the TAS gate 14 does not perform any processing when it is controlled to be in a closed state.

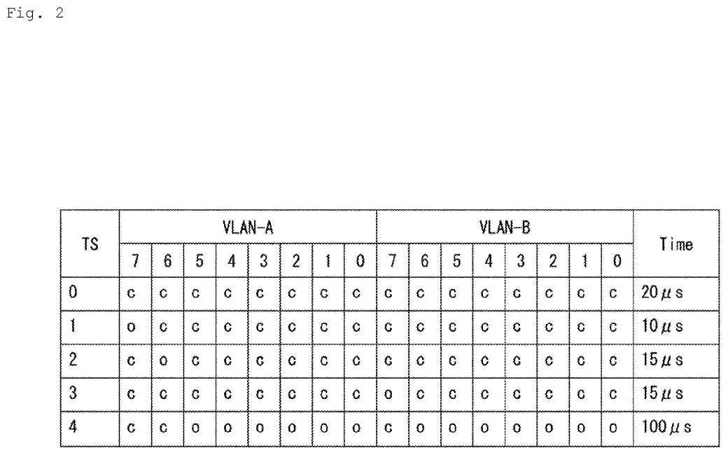

The list storage part 15 stores a GCL. As shown in FIG. 2, the GCL indicates the time of each TS (“Time” in FIG. 2). The GCL indicates the open/closed state which is either the open state or the closed state of the plurality of TAS gates 14 corresponding to the plurality of TAS queues 13 in each of the plurality of TSs. Note that, in the example shown in FIG. 2, user identifiers are represented by VLAN identifiers and “VLAN-A” and “VLAN-B” are shown as user identifiers. The same applies to the drawings which will be shown later.

At least one TS among the plurality of TSs in the GCL is a delay guarantee period during which time and open/closed state are defined so that the frame received at a predetermined timing from a predetermined transmitting device 2 is transmitted within the TS. The delay guarantee period is a period during which a frame received from the transmitting device 2 is transmitted through delay-guaranteed communication. The delay-guaranteed communication is communication in which a maximum value of end-to-end delay of communication is defined and needs to be satisfied. When the service provider provides the delay guarantee, the delay guarantee may be stipulated by a contract between the user and the service provider using the communication device 1 of the embodiment. In delay-guaranteed communication, the communication device 1 transmits a frame of a predetermined length which is received from the transmitting device 2 at a predetermined timing and has a predetermined user identifier and priority traffic class. The communication device 1 is required for transmitting frames received from the transmitting device 2 through delay guaranteed communication without a delay.

Also, at least one TS among the TSs indicated in the GCL can be a GB period during which frame transmission is not started from any of the TAS queues 13 among the plurality of TAS queues 13 provided between the BE transmission period and the delay guarantee period. Furthermore, at least one TS (for example, the last TS) among the TSs indicated in the GCL can be a BE transmission period during which the communication device 1 transmits frames with best effort. None of the TSs indicated in the GCL may be BE transmission periods.

In the example GCL shown in FIG. 2, the TS “O” time is 20 μs. Furthermore, at TS “0”, all of the TAS gates 14 are controlled to be in the closed state (c). Also, TS “0” is provided between the GB period and the TS period. Therefore, TS “0” is the GB period.

In the GCL of the example shown in FIG. 2, the TS “1” time is 10 μs. Furthermore, in the example GCL shown in FIG. 2, in TS “1”, it is shown that the TAS gate 14 corresponding to a user identifier “VLAN-A” and a priority traffic class “7” is controlled to be in an open state (o). Furthermore, in TS “1”, it is shown that the TAS gates 14 corresponding to the user identifier “VLAN-A” and priority traffic classes “6” to “0” are controlled to be in a closed state. Also, in TS “1”, it is shown that the TAS gates 14 corresponding to the user identifier “VLAN-B” and priority traffic classes “7” to “0” are controlled to be in a closed state. Here, at the start time of TS “1”, a frame is received indicating the user identifier “VLAN-A” and the priority traffic class “7” and the time of TS “1” is set to a time sufficient to transmit the frame. Therefore, TS “1” is the delay guarantee period. In the example GCL shown in FIG. 2, the time for TS “2” is 15 μs. Furthermore, in the GCL of the example shown in FIG. 2, in TS “2”, it is shown that the TAS gate 14 corresponding to the user identifier “VLAN-A” and the priority traffic class “6” is controlled to be in an open state. Also, in TS “2”, it is shown that the TAS gates 14 corresponding to the user identifier “VLAN-A” and the priority traffic classes “7” and “5” to “0” are controlled to be in a closed state. Also, in TS “2”, it is shown that the TAS gates 14 corresponding to the user identifier “VLAN-B” and priority traffic classes “7” to “0” are controlled to be in a closed state. Here, at the start time of TS “2”, a frame indicating user identifier “VLAN-A” and priority traffic class “6” is received and the time of TS “2” is set to a time sufficient to transmit the frame. Therefore, TS “2” is the delay guarantee period.

In the example GCL shown in FIG. 2, the time for TS “3” is 15 μs. Also, in the example GCL shown in FIG. 2, in TS “3”, it is shown that the TAS gates 14 corresponding to the user identifier “VLAN-A” and the priority traffic classes “7” to “0” are controlled to be in a closed state. Also, in TS “3”, it is shown that the TAS gate 14 corresponding to the user identifier “VLAN-B” and the priority traffic class “7” is controlled to be in an open state. Furthermore, in TS “3”, it is shown that the TAS gates 14 corresponding to the user identifier “VLAN-B” and the priority traffic classes “6” to “0” are controlled to be in a closed state. Here, at the start time of TS “3”, a frame indicating the user identifier “VLAN-B” and the priority traffic class “7” is received and the time of TS “3” is set to a time sufficient to transmit the frame. Therefore, TS “3” is the delay guarantee period.

In the example GCL shown in FIG. 2, the time for TS “4” is 100 μs. Also, in the example GCL shown in FIG. 2, in TS “4”, it shows that the TAS gates 14 corresponding to the user identifier “VLAN-A” and the priority traffic classes “5” to “0” are controlled to be in an open state. Also, in TS “4”, it is shown that the TAS gates 14 corresponding to the user identifier “VLAN-A” and the priority traffic classes “7” and “6” are controlled to be in a closed state. Also, in TS “4”, it is shown that the TAS gates 14 corresponding to the user identifier “VLAN-B” and the priority traffic classes “6” to “0” are controlled to be in an open state. Furthermore, in TS “4”, it is shown that the TAS gate 14 corresponding to the user identifier “VLAN-B” and the priority traffic class “7” is controlled to be in a closed state. Here, the frames held in the TAS queue 13 corresponding to the TAS gate 14 in the open state are transmitted on a best effort basis in the order in which the frames have been received. Therefore, TS “4” is the best-effort transmission period.

Note that the TS is periodically repeated. In the example shown in FIG. 2, TS is “0” until 20 μs has passed since the communication device 1 started communication control, and then TS is “1” until 10 μs has elapsed, and then TS is “2” until 15 μs has elapsed. Furthermore, after that, TS is “3” until 15 μs have elapsed, and then TS is “4” until 100 μs have elapsed. After that, TS returns to “0” and is repeated.

For this reason, when transmission of a frame started in TS “4” does not end within TS “4”, frame transmission may end within TS “0” which is the GB period in some cases. This prevents frame transmission from extending to TS “1”, and suppresses frame delay during the delay guarantee period of TS “1” to TS “3”.

A time information generating part 16 is a clock indicating a current time and generates time information indicating the current time.

A gate opening/closing part 17 acquires time information from the time information generating part 16. The gate opening/closing part 17 controls an opening/closing state of a plurality of TAS gates 14 on the basis of the current time and the GCL. Specifically, the gate opening/closing part 17 determines TSs within a range of the current time indicated using the time information. In addition, the gate opening/closing part 17 controls the TAS gate 14 to the opening/closing state shown corresponding to the TS in the GCL.

In the example shown in FIG. 2, when the gate opening/closing part 17 determines that the time is within the range of TS “0”, the gate opening/closing part 17 controls all the TAS gates 14 to be in the closed state.

Also, when the gate opening/closing part 17 determines that the time is within the range of TS “1”, the gate opening/closing part 17 controls the TAS gate 14 of the user identifier “VLAN-A” and the priority traffic class “7” to be in an open state, controls the TAS gates 14 of the user identifier “VLAN-A” and the priority traffic classes “6” to “0” to be in the closed state, and controls the TAS gates 14 of the user identifier “VLAN-B” and the priority traffic classes “7” to “0” to be in a closed state.

Furthermore, if the time is determined to be within the range of TS “2”, the gate opening/closing part 17 controls the TAS gate 14 of the user identifier “VLAN-A” and the priority traffic class “6” to be in an open state, controls the TAS gates 14 of the user identifier “VLAN-A” and the priority traffic classes “7” and “5” to “0” to be in a closed state, and controls the TAS gates 14 of the user identifier “VLAN-B” and the priority traffic classes “7” to “0” to be in a closed state.

In addition, if the time is determined to be within the range of TS “3”, the gate opening/closing part 17 controls the TAS gates 14 of the user identifier “VLAN-A” and the priority traffic classes “7” to “0” to be in a closed state, controls the TAS gate 14 of the user identifier “VLAN-B” and the priority traffic class “7” to be in an open state, and controls the TAS gates 14 of the user identifier “VLAN-B” and the priority traffic classes “6” to “0” to be in a closed state.

Moreover, if it is determined that the time is within the range of TS “4”, the gate opening/closing part 17 controls the TAS gate 14 of the user identifier “VLAN-A” and the priority traffic classes “7” and “6” to be in a closed state, controls the TAS gate 14 of the user identifier “VLAN-A” and the priority traffic classes “5” to “0” to be in the open state, controls the TAS gate 14 of the user identifier “VLAN-B” and the priority traffic class “7” to be in the closed state, and controls the TAS gate 14 of the user identifier “VLAN-B” and the priority traffic classes “6” to “0” to be in the open state.

The frame transmitting part 18 transmits the frames held in the TAS queue 13-k corresponding to the TAS gate 14-k controlled to be in an open state in the order in which the frames have been received. Specifically, the frame transmitting part 18 transmits the frame extracted from the TAS queue 13-k by the TAS gate 14-k to another device over the communication network.

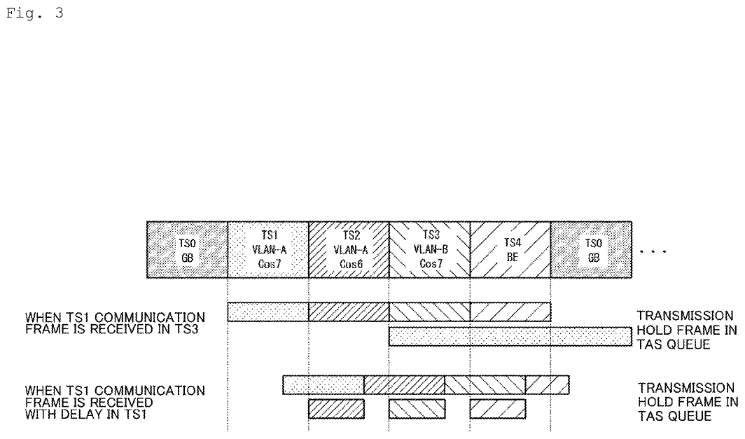

Thus, as shown in FIG. 3, in TS “1” (TS1 in the example in FIG. 3), a frame is transmitted from the TAS queue 13-k corresponding to the TAS gate 14-k with the user identifier “VLAN-A” and the priority traffic class “7” (Cos7 in the example of FIG. 3). Furthermore, in TS “2” (TS2 in the example in FIG. 3), a frame is transmitted from the TAS queue 13-k corresponding to the TAS gate 14-k with the user identifier “VLAN-A” and the priority traffic class “6” (Cos6 in the example of FIG. 3). Note that, in the example shown in FIG. 3, the Cos value is represented by an integer from “7” to “0” and the larger the number, the higher the priority, but the present disclosure is not limited thereto. Furthermore, a cos value “i (i is an integer from 7 to 0)” is indicated as “cosi”. The same applies to the drawings which will be shown later.

Here, for example, it is assumed that a frame corresponding to the user identifier “VLAN-a” and the priority traffic class “7” is delayed and received within TS “3” (TS3 in the example of FIG. 3). In this case, as shown in FIG. 2, in TS “3”, the gate opening/closing part 17 controls the TAS gate 14 of the user identifier “VLAN-A” and the priority traffic class “7” to be in a closed state and the TAS gate 14 of user identifier “VLAN-B” and priority traffic class “7” is controlled to be in an open state. For this reason, as shown in FIG. 3, in TS “3”, a frame is transmitted from the TAS queue 13-k corresponding to the TAS gate 14-k with the user identifier “VLAN-B” and the priority traffic class “7”. Moreover, in TS “3”, a frame is not transmitted from TAS queue 13-k corresponding to user identifier “VLAN-A” and priority traffic class “7”, and after the next cycle, continues to be held in the TAS queue 13-k until the TAS gate 14-k corresponding to that TAS queue 13-k is opened.

Note that, as shown in FIG. 3, in TS “1”, when a frame with the user identifier “VLAN-A” and the priority traffic class “7” is received with a delay, the TAS gate 14-k extracts the delayed received frame from the TAS queue 13-k and the frame transmitting part 18 transmits the frame to another device over the communication network. For this reason, the transmission of the frame may end within TS “2” immediately after TS “1” in some cases, and in this case, in TS “2”, the start of transmission of frames indicating the user identifier “VLAN-A” and the priority traffic class “6” is delayed. In this way, when the reception of a frame though delay guaranteed communication is delayed within a TS, the transmission of frames in subsequent TSs may be delayed by a maximum of one frame in some cases.

### <Operation of Communication Device>

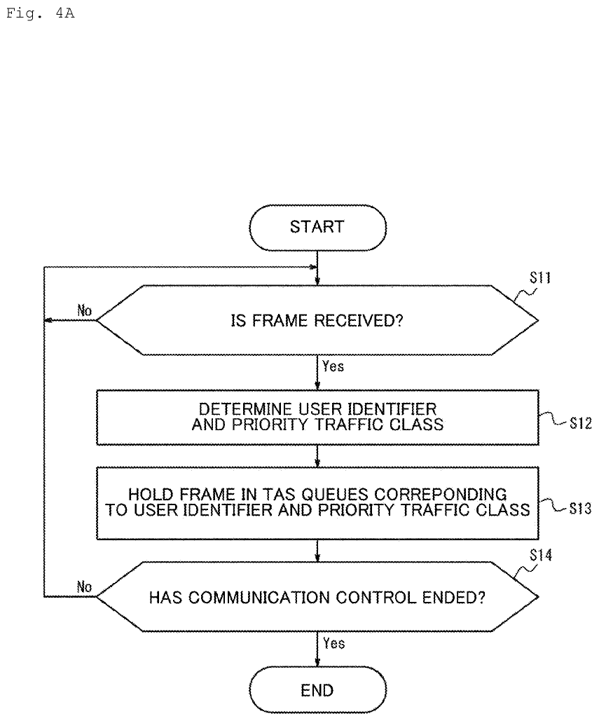

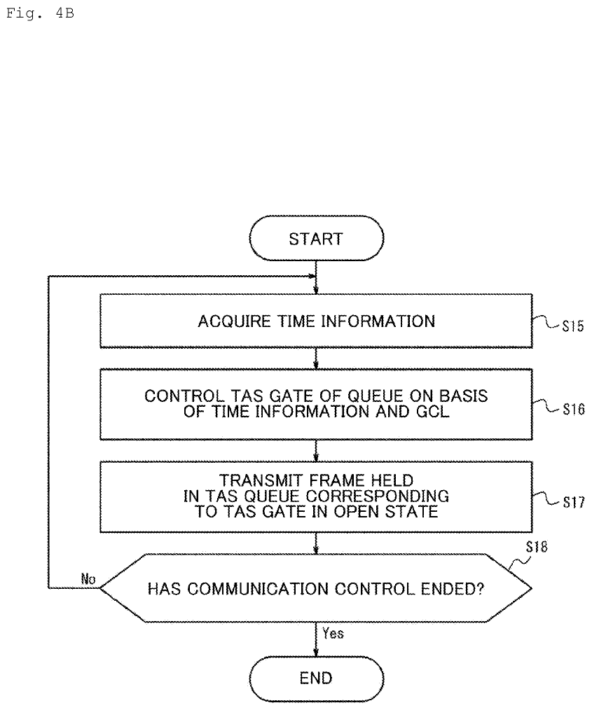

Here, an operation of the communication device 1 according to the first embodiment will be described with reference to FIGS. 4A and 4B. FIGS. 4A and 4B are flowcharts for describing an example of the operation of the communication device 1 according to the first embodiment. The operation of the communication device 1 described with reference to FIGS. 4A and 4B corresponds to an example of a scanning method of the communication device 1 according to the first embodiment.

First, the operation of communication device 1 for holding frames will be described with reference to FIG. 4A. In this operation, the frame receiving part 11 receives frames from the plurality of transmitting devices 2.

In Step S11, the determining part 12 determines whether the frame receiving part 11 has received a frame.

When it is determined in Step S11 that a frame has not been received, the determining part 12 repeatedly performs the process of Step S11 again.

If it is determined in Step S11 that a frame has been received, in Step S12, the determining part 12 determines a user identifier for identifying a user of the transmitting device 2 which has transmitted the frame and a priority traffic class indicating the priority of the frame.

In Step S13, the determining part 12 holds the frame in the TAS queue 13 corresponding to the user identifier and the priority traffic class. Thus, the TAS queue 13 holds frames for each user identifier and priority traffic class.

In Step S14, the communication device 1 determines whether to end communication control. For example, it may be determined whether the communication device 1 has received an instruction to end communication control.

If it is determined in Step S14 that the communication control is terminated, the communication device 1 terminates the process. If it is determined in Step S14 that the communication control does not end, the communication device 1 returns to Step S11 and repeatedly performs the process.

An operation of transmitting frames held by communication device 1 will be described below with reference to FIG. 4B.

In Step S15, the gate opening/closing part 17 acquires time information from the time information generating part 16.

In Step S16, the gate opening/closing part 17 controls the opening/closing state which is either the open state or the closed state of the plurality of TAS gates 14 on the basis of the current time and the GCL. Specifically, the gate opening/closing part 17 determines a TS whose time indicated by the time information acquired from the time information generating part 16 is within the range. Moreover, the gate opening/closing part 17 controls the TAS gate 14 to be in the opening/closing state corresponding to the TS in the GCL.

Here, at least one TS among the plurality of TSs in the GCL is a delay guarantee period during which the time and open/close state of the TS are defined so that a frame received at a predetermined timing from a predetermined transmitting device 2 is transmitted within the TS.

In Step S17, the frame transmitting part 18 transmits the frames held in the TAS queue 13-k corresponding to the TAS gate 14-k controlled to be in an open state in the order in which the frames have been received. Specifically, the open TAS gate 14-k extracts the frame held in the TAS queue 13-k corresponding to the TAS gate 14-k. Moreover, the frame transmitting part 18 transmits the frame extracted by the TAS gate 14-k.

In Step S18, the communication device 1 determines whether to end communication control. For example, it may be determined whether the communication device 1 has received an instruction to end communication control.

If it is determined in Step S18 that the communication control is terminated, the communication device 1 ends the process. If it is determined in Step S18 not to end communication control, the communication device 1 returns to Step S15 and repeatedly performs the process.

As described above, according to the first embodiment, the communication device 1 includes the plurality of TAS queues 13 which each holds a frame for each user identifier and each priority traffic class and the list storage part 15 which stores a GCL indicating time for each of the plurality of TASs and an open/closed state which is either an open state or a closed state of the plurality of TAS gates 14 corresponding to the plurality of TAS queues 13 in each of the plurality of TSs. Furthermore, at least one TS among a plurality of TSs in the GCL is a delay guarantee period during which the time and switching state of the TS are defined so that a frame received at a predetermined timing from a predetermined transmitting device 2 is transmitted within the TS. For this reason, the communication device 1 can more reliably prevents delays in frames transmitted through delay guaranteed communication. Specifically, when the reception of a frame through delay guaranteed communication from one transmitting device 2 is delayed, the communication device 1 can prevent the delays of frames received from another transmitting device 2 through delay guaranteed communication.

### Second Embodiment

The overall configuration of a second embodiment will be described. Functional parts in the second embodiment that are the same as those in the first embodiment are denoted by the same reference numerals and description thereof is omitted. A communication system 100 including a plurality of transmitting devices 2 and a communication device 1 configured to receive frames from each of the plurality of transmitting devices 2 may be configured.

### <Configuration of Communication Device>

As in the first embodiment described with reference to FIG. 1, the communication device 1 of the second embodiment includes a frame receiving part 11, a determining part 12, a plurality of TAS queues 13, a plurality of TAS gates 14, a list storage part 15, a time information generating part 16, a gate opening/closing part 17, and a frame transmitting part 18.

As in the first embodiment, at least one TS among the TS indicated in the GCL stored in the list storage part 15 is the delay guarantee period. Furthermore, at least one TS among the TS indicated in the GCL stored in the list storage part 15 can be a GB period provided between the BE transmission period and the delay guarantee period during which the communication device 1 does not start transmitting frames. In addition, at least one TS (for example, the last TS) among the TS indicated in the GCL stored in the list storage part 15 can be set as the best effort transmission period. None of the TSs indicated in the GCL may be BE transmission periods.

Unlike the first embodiment, in the GCL stored in the list storage part 15, the delay guaranteed period is classified into a transmission start permission period and a transmission start prohibition period and defined. Compared to the delay guarantee period which has been set to be sufficiently long to complete the frame transmission, for the transmission start permission period, it is possible to set a short time during which frame transmission need not be completed, and the TAS gate 14 for delay guaranteed communication is controlled to be in an open state. The TS between the delay guaranteed period and the delay guaranteed period next to the delay guaranteed period is a transmission start prohibition period during which none of the TAS queues 13 among the plurality of TAS queues 13 start transmitting frames. The frame transmitting part 18 completes the frame transmission when the frame transmission is not completed during the transmission start permission period during the transmission start prohibition period.

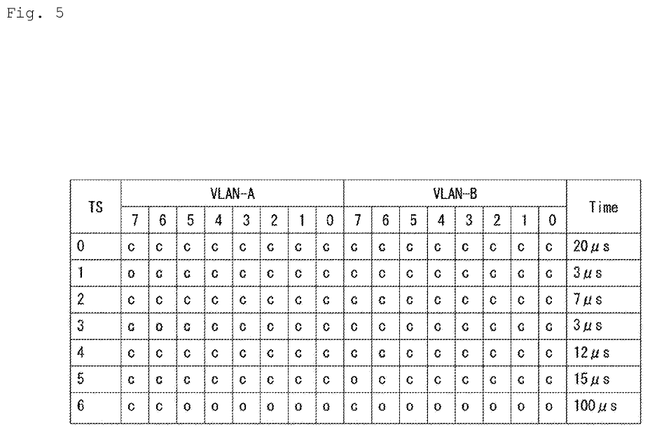

In the GCL of the example shown in FIG. 5, TSs “1” to “2”, “3” to “4”, and “5” are delay guarantee periods, respectively. TS “0” is a GB period provided between TS “6” which is the BE transmission period and TS “1” which is the delay guarantee period. TS “1” and TS “3” are transmission start permission periods. TS “2” is a transmission start prohibition section provided between TS “1” and TS “3” which are delay guaranteed periods. TS “4” is a transmission start prohibition section provided between TS “3” and TS “5” which are delay guaranteed periods. Furthermore, in TS “0”, TS “2”, and TS “4”, it is shown that the TAS gates 14 corresponding to all user identifiers and priority traffic classes are controlled to be in a closed state.

The transmission start prohibition period can be any time less than or equal to the time required to transmit the longest frame. The transmission start permission period can be set to any time within the range in which the transmission start permission period does not exceed the delay guaranteed period. As an example, the transmission start permission period may be set on the basis of a maximum delay jitter which can occur in the communication network used for frame transmission/reception between the communication device 1 and the transmitting device 2.

In addition, although the transmission start prohibition period can be the time required for transmitting the longest frame and the communication efficiency is reduced in such a configuration, it is possible to avoid affecting the TS after the transmission start prohibition period. Note that, since the delay of frames transmitted during the best-effort transmission period is not guaranteed, as in the example shown in FIG. 5, the TS immediately before TS “6” which is the best-effort transmission period need not be the transmission start prohibition period.

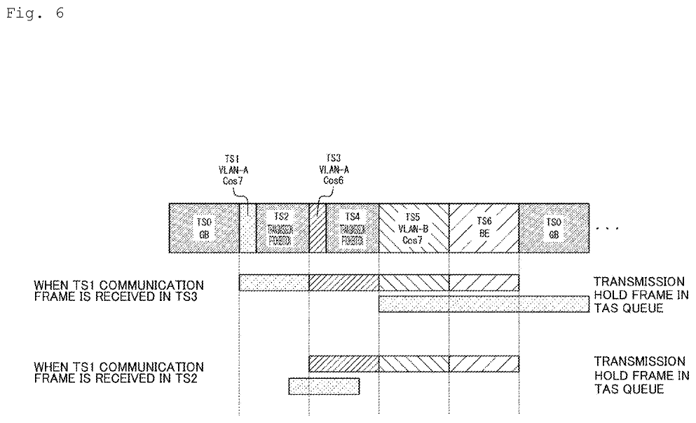

When the GCL is configured as described above, as shown in FIG. 6, in TS “1”, the transmission of frames from the TAS queue 13 corresponding to the user identifier “VLAN-A” and the priority traffic class “7” is started. In TS “2”, frames from all of the TAS queues 13 are prohibited from starting transmission. In TS “3”, the transmission of frames from the TAS queue 13 corresponding to the user identifier “VLAN-A” and the priority traffic class “6” is started. In TS “4”, frames from all of the TAS queues 13 are prohibited from starting transmission. In TS “5”, transmission of frames from the TAS queue 13 corresponding to the user identifier “VLAN-B” and the priority traffic class “7” is started.

Here, for example, it is assumed that a frame corresponding to the user identifier “VLAN-A” and the priority traffic class “7” is delayed and received within TS “5” (TS5 in the example of FIG. 6). In this case, as shown in FIG. 5, the TAS gate 14 of the user identifier “VLAN-A” and the priority traffic class “7” is controlled to be in a closed state and the TAS gate 14 of the user identifier “VLAN-B” and the priority traffic class “7” is controlled to be in an open state. For this reason, as shown in FIG. 6, in TS “5”, frames are transmitted from the TAS queue 13-k corresponding to the TAS gate 14-k of the user identifier “VLAN-B” and the priority traffic class “7” (Cos7 in the example of FIG. 6). Also, in TS “5”, the frames received with a delay are not transmitted, and in the next cycle, the TAS queue 13-k continues to hold the frames until the TAS gate 14-k corresponding to the TAS queue 13-k is in an open state.

Furthermore, as shown in FIG. 6, in TS “1”, if the frame of the user identifier “VLAN-A” and the priority traffic class “7” (Cos7 in the example of FIG. 6) is delayed and received in TS “2”, the frame is not transmitted. In addition, the frame subsequently continues to be held in the TAS queue 13-k until the TAS gate 14-k corresponding to the TAS queue 13-k is in an open state. For this reason, in TS “3”, the frame indicating the user identifier “VLAN-A” and the priority traffic class “6” (Cos6 in the example of FIG. 6) is transmitted without a delay. Similarly, in TS “5”, the frame indicating the user identifier “VLAN-B” and the priority traffic class “7” (Cos7 in the example of FIG. 6) is transmitted without a delay.

Moreover, when the frame pre-emption specified in the IEEE 802.1Qbu is applied and the start of transmission of the frame held in the TAS queue 13-k with the TAS gate 14-k in the open state is delayed, a portion of the frame may be transmitted, a portion thereof may be held in the TAS queue 13-k, and transmission may be suspended until the TAS gate 14-k is in an open state in the next cycle. Thus, it is possible to prevent the transmission of the frame from ending in the TS and continuing the transmission in the immediately following TS.

### <Operation of Communication Device>

An operation of the communication device 1 according to the second embodiment is the same as the operation of the communication device 1 according to the first embodiment. Here, the GCL used by the gate opening/closing part 17 to open/close the TAS gate 14 is different.

As described above, according to the second embodiment, in the communication device 1, the TS between the delay guaranteed period in the GCL and the delay guaranteed period next to the delay guaranteed period is a transmission start prohibition period during which frame transmission is not started from any of the TAS queues 13 among the plurality of TAS queues 13. For this reason, even if the frame transmitted through the delay guaranteed communication is received with a delay in the TS (TS1 in the example shown in FIG. 6) in which the frame is transmitted using the communication device 1, the communication device 1 can prevent the delay of frames received from another transmitting device 2 as delay guaranteed communication.

### Third Embodiment

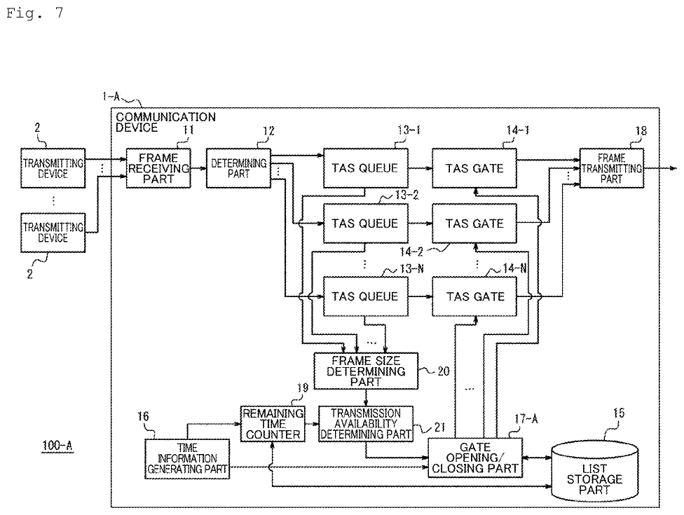

The overall configuration of a third embodiment will be described with reference to FIG. 7. FIG. 7 is a schematic diagram of a communication device 1-A according to the third embodiment. Functional parts that are the same as those in the first embodiment are denoted by the same reference numerals and description thereof is omitted. A communication system 100-A including a plurality of transmitting devices 2 and a communication device 1-A configured to receive frames from each of the plurality of transmitting devices 2 may be configured.

### <Configuration of Communication Device>

As shown in FIG. 7, the communication device 1-A according to the third embodiment includes a frame receiving part 11, a determining part 12, a plurality of TAS queues 13, a plurality of TAS gates 14, a list storage part 15, a time information generating part 16, a gate opening/closing part 17-A, and a frame transmitting part 18, a remaining time counter 19, a frame size determining part 20, and a transmission availability determining part 21. In the third embodiment, the GCL stored in the list storage part 15 is the same as the GCL stored in the list storage part 15 in the first embodiment described with reference to FIG. 2.

The gate opening/closing part 17-A and the transmission availability determining part 21 constitute a control part. The remaining time counter 19 is configured of a counter configured to count time.

The remaining time counter 19 counts the remaining time until the end time of each TS on the basis of the time information acquired from the time information generating part 16 and the GCL.

The frame size determining part 20 determines a frame length which is a length of a frame held in the TAS queue 13.

The gate opening/closing part 17-A controls an opening/closing state of the TAS gate 14 on the basis of a current time indicated by the time information, the GCL, and the determination result of the transmission availability determining part 21.

Specifically, first, the gate opening/closing part 17-A determines TSs within a range of the current time indicated by the time information.

Also, the gate opening/closing part 17-A determines whether the TS is a delay guarantee period. When it is determined that the TS is the delay guarantee period, the gate opening/closing part 17-A controls the open/closed state of the TAS gate 14 on the basis of the determination result of the transmission availability determining part 21.

Specifically, the gate opening/closing part 17-A determines whether the GCL indicates that the TAS gate 14 is in an open state.

If the GCL indicates that the TAS gate 14-k is in a closed state, the gate opening/closing part 17-A controls the TAS gate 14-k to be in a closed state.

If the gate opening/closing part 17-A determines that the GCL indicates that the TAS gate 14-k is in an open state, the transmission availability determining part 21 determines whether the remaining time of the TS is the frame transmission time or longer.

If the gate opening/closing part 17-A determines the TAS gate 14-k shown to be in an open state in the GCL, the transmission availability determining part 21 determines whether the remaining time counted by the remaining time counter 19 is the frame transmission time or longer. At this time, the transmission availability determining part 21 may calculate the frame transmission time on the basis of the frame length and the egress port speed. The transmission availability determining part 21 may calculate a value obtained by dividing the frame length by the egress port speed as the frame transmission time.

When it is determined that the remaining time is the frame transmission time or longer, the gate opening/closing part 17-A controls the TAS gate 14-k to be in an open state.

Furthermore, when it is determined that the remaining time is less than the frame transmission time, the gate opening/closing part 17-A controls the TAS gate 14-k to be in a closed state.

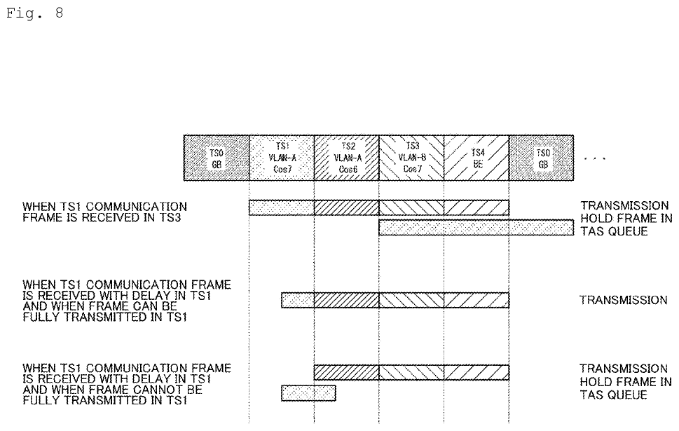

Thus, as shown in FIG. 8, in TS “1”, a frame is transmitted from the TAS queue 13 corresponding to the user identifier “VLAN-A” and the priority traffic class “7” (Cos7 in the example of FIG. 8). Furthermore, in TS “2”, a frame is transmitted from the TAS queue 13 corresponding to the user identifier “VLAN-A” and the priority traffic class “6” (Cos6 in the example of FIG. 8).

Here, for example, it is assumed that a frame corresponding to the user identifier “VLAN-A” and the priority traffic class “7” is delayed and received in TS “3” (TS3 in the example of FIG. 8). In this case, as shown in FIG. 2, in TS “3”, the gate opening/closing part 17-A controls the TAS gate 14 of the user identifier “VLAN-A” and the priority traffic class “7” to be in a closed state and the TAS gate 14 of the user identifier “VLAN-B” and the priority traffic class “7” is controlled to be in an open state. For this reason, a frame is transmitted from the TAS queue 13-k corresponding to the TAS gate 14-k of the user identifier “VLAN-B” and the priority traffic class “7”. Moreover, a frame is not transmitted from the TAS queue 13-k corresponding to the user identifier “VLAN-A” and the priority traffic class “7” and the frame continues to be held in the TAS queue 13-k until the TAS gate 14-k corresponding to the TAS queue 13-k is in an open state in the next cycle.

Furthermore, as shown in FIG. 8, when a frame of the user identifier “VLAN-A” and the priority traffic class “7” (Cos7 in the example of FIG. 8) is delayed and received in TS “1”, if the remaining time is determined to be less than the frame transmission time, the frame is not transmitted. The frame continues to be held in the TAS queue 13-k until the TAS gate 14-k is controlled to be in an open state in the next cycle. In addition, if it is determined that the remaining time is the frame transmission time or longer, the frame is transmitted. For this reason, in TS “2” immediately after TS1, transmission of the frame indicating the user identifier “VLAN-A” and the priority traffic class “6” is started without a delay, and in TS “1”, the frame can be transmitted efficiently without wasting the remaining time.

Furthermore, when the frame pre-emption specified in the IEEE 802.1Qbu is applied and the transmission start of the frame held in the TAS queue 13 with the TAS gate 14-k in the open state is delayed, a portion of the frame may be transmitted, a portion thereof may be held in the TAS queue 13, and transmission may be suspended until the TAS gate 14-k is controlled to be in an open state after the next cycle. Thus, it is possible to prevent the transmission of the frame from ending in the TS and continuing the transmission in the immediately following TS.

### <Operation of Communication Device>

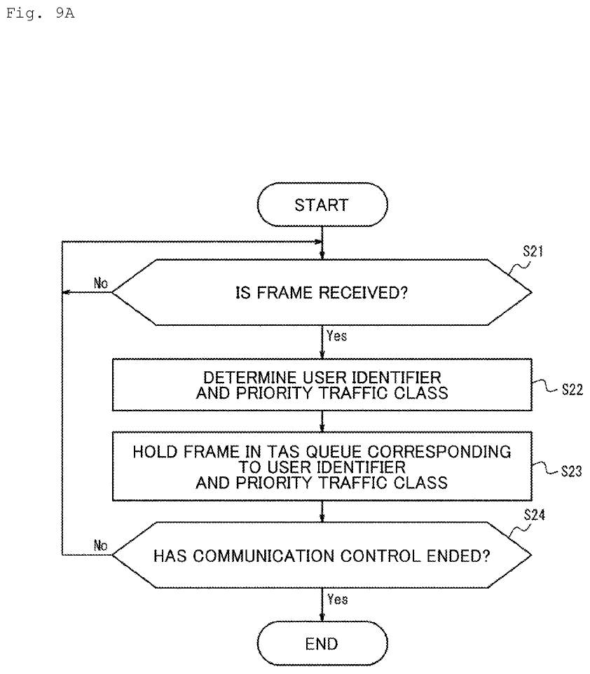

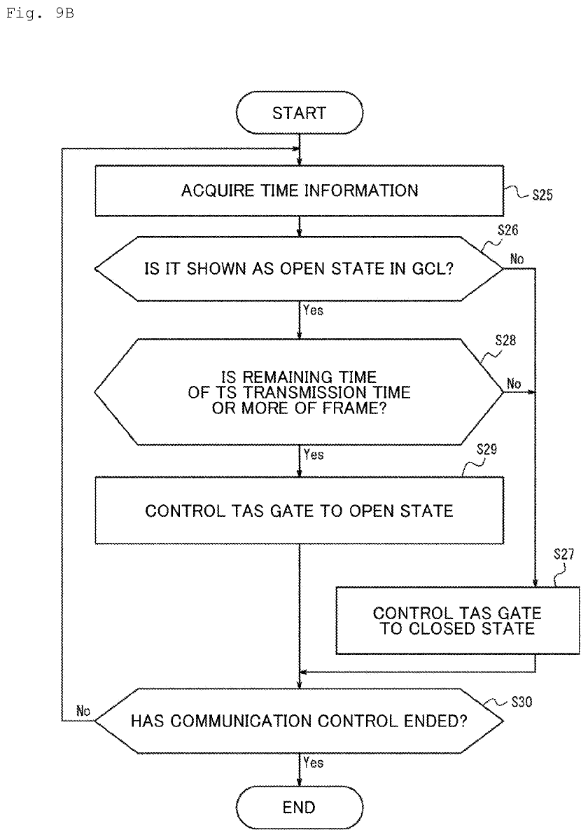

Here, an operation of the communication device 1-A according to the third embodiment will be described with reference to FIGS. 9A and 9B. FIGS. 9A and 9B are sequence diagrams showing an example of the operation of the communication device 1-A according to the third embodiment. The operation of the communication device 1-A described with reference to FIGS. 9A and 9B corresponds to an example of the scanning method of the communication device 1-A according to the third embodiment.

First, referring to FIG. 9A, the operation of the communication device 1-A for holding a frame will be described.

The communication device 1-A performs the processes from Step S21 to Step S24. The processing from Step S21 to Step S24 is the same as the processing from Step S11 to Step S14 in the first embodiment.

Referring to FIG. 9B, the operation for transmitting the frame held by the communication device 1-A will be described below.

In Step S25, the gate opening/closing part 17-A acquires time information from the time information generating part 16.

In Step S26, the gate opening/closing part 17-A determines whether the TAS queue 13-k is in an open state at the TS within the range of the current time in the GCL.

If it is determined in Step S26 that the TAS queue 13-k is indicated in a closed state in the GCL, then in Step S27, the gate opening/closing part 17-A controls the TAS gate 14-k to be in a closed state.

If it is determined in Step S26 that the TAS queue 13-k is shown to be in an open state in the GCL, in step S28, the transmission availability determining part 21 determines whether the remaining time of the TS counted by the remaining time counter 19 is the frame transmission time or longer.

If it is determined in Step S28 that the remaining time of the TS is less than the frame transmission time, in Step S27, the gate opening/closing part 17-A controls the TAS gate 14-k to be in a closed state.

If it is determined in Step S28 that the remaining time of the TS is the transmission time of the frame or longer, in Step S29, the gate opening/closing part 17-A controls the TAS gate 14-k to be in an open state.

In Step S30, the communication device 1-A determines whether to end communication control. For example, it may be determined whether the communication device 1-A has received an instruction to end communication control.

If it is determined in Step S30 to end the communication control, the communication device 1-A ends the process. If it is determined in Step S30 not to end the communication control, the communication device 1-A returns to Step S25 and repeatedly performs the process.

As described above, according to the third embodiment, the communication device 1-A further includes a frame size determining part 20 which determines a frame length which is a length of a frame held in the TAS queue 13-k and a transmission availability determining part 21 which determines whether the remaining time of the TS including the current time is the transmission time of the frame or longer based on the frame length. Also, if it is determined that the remaining time is the transmission time or longer, the gate opening/closing part 17-A controls the TAS gate 14-k corresponding to the TAS queue 13-k holding the frame to be in an open state. In addition, if it is determined that the remaining time is less than the transmission time, the gate opening/closing part 17-A controls the TAS gate 14-k to be in a closed state. Thus, even if the frame transmitted through the delay guaranteed communication is received with a delay in the TS transmitted using the communication device 1-A, the communication device 1-A can prevent the delay of frames received from another transmitting device 2 as delay guaranteed communication. Moreover, the communication device 1-A can efficiently transmit frames.

### <Program>

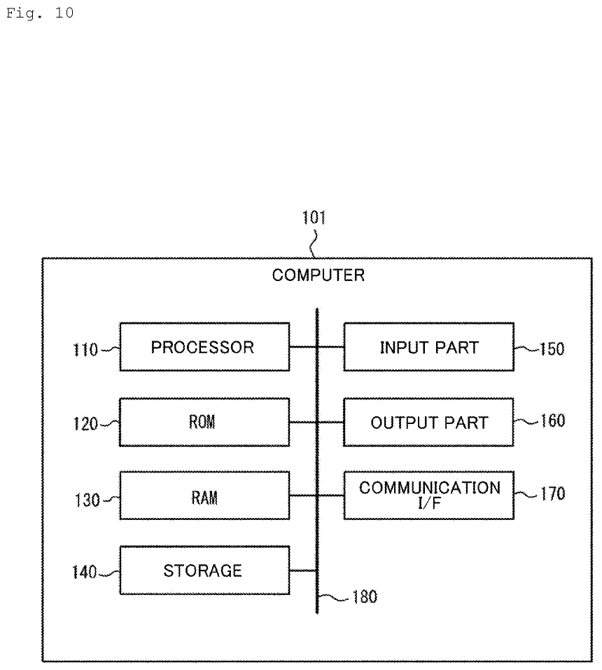

The communication devices 1 and 1-A described above can be realized using the computer 101. Furthermore, a program for functioning as the communication devices 1 and 1-A may be provided. In addition, the program may be stored in a storage medium or provided over a network. FIG. 10 is a block diagram showing a schematic configuration of a computer 101 functioning as communication devices 1 and 1-A. Here, the computer 101 may be a general-purpose computer, a dedicated computer, a workstation, a personal computer (PC), an electronic notepad, or the like. Program instructions may be program codes, code segments, or the like for performing the required tasks.

As shown in FIG. 10, the computer 101 includes a processor 110, a read only memory (ROM) 120, a random access memory (RAM) 130, a storage 140, an input part 150, a display part 160, and a communication interface (I/F) 170. Constituent elements are communicatively connected to each other via a bus 180. The processor 110 is specifically a central processing unit (CPU), a micro processing unit (MPU), a graphics processing unit (GPU), a digital signal processor (DSP), a system on a chip (SoC), and the like and may be composed of multiple processors of the same type or different types.

The processor 110 controls each constituent element and performs various kinds of arithmetic processing. That is to say, the processor 110 reads a program from the ROM 120 or the storage 140 and executes the program using the RAM 130 as a work region. The processor 110 performs control of each constituent element and various arithmetic processing in accordance with programs stored in the ROM 120 or the storage 140. In the embodiment described above, the ROM 120 or the storage 140 stores the program according to the present disclosure.

The program may be stored in a storage medium readable by the computer 101. If such a storage medium is used, a program can be installed on the computer 101. Here, the storage medium storing the program may be a non-transitory storage medium. The non-transitory storage medium is not particularly limited, but may be, for example, a CD-ROM, a DVD-ROM, a universal serial bus (USB) memory, or the like. Also, this program may be downloaded from an external device over a network.

The ROM 120 stores various programs and various data. The RAM 130 temporarily stores programs or data as a work region. The storage 140 is configured of a hard disk drive (HDD) or a solid state drive (SSD) and stores various programs including an operating system and various data.

The input part 150 includes one or more input interfaces through which user input operations are received and information based on the user operations is acquired. For example, the input part 150 is a pointing device, a keyboard, a mouse, or the like, but is not limited to these.

The display part 160 includes one or more output interfaces for outputting information. For example, the display part 160 is a display configured to output information as a video or a speaker configured to output information as an audio, but is not limited to these. Note that the display part 160 also functions as the input part 150 when it is a touch panel type display.

A communication interface (I/F) 170 is an interface for communicating with an external device.

The following additional remarks are disclosed regarding the above embodiments.

(Supplementary Item 1)

A communication device comprising:
a communication interface through which frames are received from a plurality of transmitting devices;
a control part which determines a user identifier for identifying a user of the transmitting device which has transmitted the frame and a priority traffic class which indicates a priority of the frame;
a buffer memory which holds the frame for each of the user identifier and the priority traffic class; and
a memory which stores a gate control list indicating times in a plurality of time slots and open/closed states which are either an open state or a closed state of a plurality of gates corresponding to a plurality of queues in each of the plurality of time slots,
wherein the control part further controls the open/closed states of the plurality of gates on the basis of a current time and the gate control list,
The communication interface transmits the frames held in the queue corresponding to the gate controlled to be in the open state in the order in which the frames are received, and at least one time slot among the plurality of time slots in the gate control list is a delay guarantee period during which the time and the opening/closing state are defined so that a frame receives at a predetermined timing from a predetermined transmitting device is transmitted in the time slot.

(Supplementary Item 2)

The communication device according to Supplement Item 1, in which, in the gate control list, a time slot between the delay guaranteed period and the delay guaranteed period next to the delay guaranteed period is a transmission start prohibition period during which frame transmission is not started from any of the plurality of queues.

(Supplementary Item 3)

The communication device according to Supplementary Item 1, in which the control part further
determines a frame length which is a length of the frame held in the queue,
determines whether a remaining time of a time slot including a current time is a transmission time or longer of the frame based on the frame length, and
controls the gate corresponding to the queue holding the frame to be in an open state if it is determined that the remaining time is the transmission time or longer and controls the gate to be in a closed state if it is determined that the remaining time is less than the transmission time.

(Supplementary Item 4)

A communication system including a plurality of transmitting devices and a communication device which receives frames from each of the plurality of transmitting devices, in which the communication device includes:
a communication interface through which frames are received from the plurality of transmitting devices;
a control part which determines a user identifier for identifying a user of the transmitting device which has transmitted one of the frames and a priority traffic class which indicates a priority of the frame;
a buffer memory which holds each of the frames for each of the user identifiers and the priority traffic classes; and
a memory which stores a gate control list indicating times of a plurality of time slots and open/closed states which either open states or closed states of a plurality of gates corresponding to the plurality of queues in each of the plurality of time slots, in which
the control part further controls the open/closed states of the plurality of gates on the basis of a current time and the gate control list,
the communication interface transmits the frames held in the queue corresponding to the gate controlled to be in the open state in the order in which the frames are received, and at least one time slot among the plurality of time slots in the gate control list is a delay guarantee period in which the time and the open/closed state are defined so that a frame received at a predetermined timing from a predetermined transmitting device is transmitted in the time slot.

(Supplementary Item 5)

A communication method performed by a communication device including a storage part which stores a gate control list indicating times of a plurality of time slots and open/closed states which are either open states or closed states of a plurality of gates corresponding to the plurality of queues in each of the plurality of time slots, including:
a step of receiving frames from a plurality of transmitting devices;
a step of determining a user identifier for identifying a user of the transmitting device which has transmitted the frame and a priority traffic class indicating a priority of the frame;
a step of holding the frame in each of the queues for each user identifier and priority traffic class;
a step of controlling the open/closed states of the plurality of gates on the basis of a current time and the gate control list; and
a step of transmitting the frames held in the queue corresponding to the gate controlled to be in the open state in the order in which the frames are received, in which at least one time slot among the plurality of time slots in the gate control list is a delay guarantee period in which the time and the open/closed state are defined so that a frame received at a predetermined timing from a predetermined transmitting device is transmitted in the time slot.

All documents, patent applications, and technical standards described in the specification are incorporated in the specification by reference to the extent that individual documents, patent applications, and technical standards are specifically and individually noted that they are incorporated by reference.

Although the above embodiments have been described as representative examples, it will be apparent to those skilled in the art that many modifications and substitutions can be made within the spirit and scope of this disclosure. Therefore, the present disclosure should not be construed as limited by the above-described embodiments, and various modifications and changes are possible without departing from the scope of the claims. For example, it is possible to combine a plurality of configuration blocks described in the configuration diagrams of the embodiments into one, or divide one configuration block.

### REFERENCE SIGNS LIST

1, 1-A communication device
2 Transmitting device
11 Frame receiving part
12 Determining part
13, 13-k TAS queue (queue)
14, 14-k TAS gate (gate)
15 List storage part
16 Time information generating part
17, 17-A Gate opening/closing part
18 Frame transmitting part
19 Remaining time counter
20 Frame size determining part
21 Transmission availability determining part
100, 100-A Communication system
101 Computer
110 Processor
120 ROM
130 RAM
140 Storage
150 Input part
160 Output part
170 Communication interface
180 Bus

1. A communication device comprising:
processing circuitry configured to
receive frames from a plurality of transmitting devices;
determine a user identifier for identifying a user of the transmitting device which has transmitted the frame and a priority traffic class which indicates a priority of the frame;
maintain a plurality of queues which hold the frame for each of the user identifier and the priority traffic class;
store a gate control list indicating times in a plurality of time slots and open/closed states which are either an open state or a closed state of a plurality of gates corresponding to a plurality of queues in each of the plurality of time slots;
control the open/closed states of the plurality of gates on the basis of a current time and the gate control list; and
transmit the frames held in the queue corresponding to the gate controlled to be in the open state in an order in which the frames are received,
wherein at least one time slot among the plurality of time slots in the gate control list is a delay guarantee period during which the time and the opening/closing state are defined so that a frame received at a predetermined timing from a predetermined transmitting device is transmitted in the time slot.

2. The communication device according to claim 1, wherein, in the gate control list, a time slot between the delay guaranteed period and the delay guaranteed period next after the delay guaranteed period is a transmission start prohibition period during which frame transmission is not started from any of the plurality of queues.

3. The communication device according to claim 1, further comprising:
processing circuitry configured to
determine a frame length which is a length of the frame held in the queue; and
determine whether a remaining time of a time slot including a current time is a transmission time or longer of the frame based on the frame length,
wherein the gate opening/closing part controls the gate corresponding to the queue holding the frame to be in an open state if it is determined that the remaining time is the transmission time or more and controls the gate to be in a closed state if it is determined that the remaining time is less than the transmission time.

4. A communication system including a plurality of transmitting devices and a communication device which receives frames from each of the plurality of transmitting devices,
wherein the communication device includes:
processing circuitry configured to
receive frames from the plurality of transmitting devices;
determine a user identifier for identifying a user of the transmitting device which has transmitted the frames and a priority traffic class which indicates a priority of the frame;
maintain a plurality of queues which hold the frames for each of the user identifiers and the priority traffic classes;
store a gate control list indicating times for each of a plurality of time slots and open/closed states which are either open states or closed states of a plurality of gates corresponding to the plurality of queues in each of the plurality of time slots;
control the open/closed states of the plurality of gates on the basis of a current time and the gate control list; and
transmit the frames held in the queue corresponding to the gate controlled to be in the open state in an order in which the frames are received,
wherein at least one time slot among the plurality of time slots in the gate control list is a delay guarantee period during which the time and the opening/closing state are defined so that a frame received at a predetermined timing from a predetermined transmitting device is transmitted in the time slot.

5. A communication method performed by a communication device including a storage that stores a gate control list indicating times of a plurality of time slots and open/closed states of a plurality of gates corresponding to the plurality of queues in each of the plurality of time slots, comprising:
receiving frames from a plurality of transmitting devices;
determining a user identifier for identifying a user of the transmitting device which has transmitted the frame and a priority traffic class indicating a priority of the frame;
holding the frame in each of the queues for each user identifier and priority traffic class;
controlling the open/closed states of the plurality of gates based on a current time and the gate control list; and
transmitting the frames held in the queue corresponding to the gate controlled to be in the open state in the order in which the frames are received,
wherein at least one time slot among the plurality of time slots in the gate control list is a delay guarantee period in which the time and the open/closed state are defined so that a frame received at a predetermined timing from a predetermined transmitting device is transmitted in the time slot.
